(19) United States
(12) Patent Application Publication
(10) Pub. No.: US 2020/0321647 A1
(43) Pub. Date: Oct. 8, 2020

(54) NEW ASSEMBLY METHOD TO INSTALL SHEET MATERIAL

(71) Applicant: Hanon Systems, Daejeon (KR)

(72) Inventors: Qiong Zhang, Farmington Hills, MI (US); Dave Letteer, Brighton, MI (US); Carl Walzer, Novi, MI (US)

(21) Appl. No.: 16/375,901

(22) Filed: Apr. 5, 2019

(51) Int. Cl. H01M 10/04; H01M 10/6554; H01M 10/613

(52) U.S. Cl. CPC H01M 10/0404; H01M 10/613; H01M 10/6554

(57) ABSTRACT

A method of applying sheet material onto a plate or a surface, such as a cooling plate for use with a battery, is disclosed. The method comprises the steps of: providing a cylinder roller configured to selectively adhere a sheet material to an outer surface thereof, picking the sheet from a substrate by rotating the cylinder roller relative to the substrate, and placing the sheet on the plate or surface by rotating the cylinder roller relative to the plate or surface. The outer surface of the cylinder roller is divided circumferentially into an adhesion portion and a non-adhesion portion. The adhesion portion is configured to provide an adhesion force for adhering the sheet to the outer surface of the cylinder roller while the non-adhesion portion remains stationary relative to an axis of rotation of the cylinder roller during the rotating of the cylinder roller relative to the substrate and the plate or surface.

### FIELD OF THE INVENTION

The present invention relates to a system for installing a sheet material on a substantially planar surface and a method of using the same, and more particularly, to a system and method for installing a sheet of material onto a substantially planar surface of a plate.

### BACKGROUND OF THE INVENTION

Electric vehicles and hybrid electrical vehicles typically include relatively large battery assemblies for generating the power necessary to drive the associated vehicle. The batteries forming such assemblies tend to generate significant heat during operation thereof, therefore it is important to continuously remove heat from each of the batteries in order to maintain a desired temperature range of the associated battery.

One method of cooling the batteries forming the battery assembly includes placing a cooling plate in heat exchange relationship with the associated battery, wherein the cooling plate may form a heat sink having suitable properties of thermal conduction. However, because such cooling plates are commonly formed from electrically conductive materials such as metallic materials, a possibility of the formation of a short circuit exists if the electrically conductive cooling plate is placed in direct contact with an electrically conductive surface of the associated battery.

In order to prevent such a short circuit, it is common for such battery assemblies to include a layer of “thermal interface material” (TIM) intermediate the cooling plate and the associated battery. The TIM may be presented as a sheet material selected to include a desired degree of thermal conductivity while remaining substantially electrically non-conductive to electrically insulate the battery from the cooling plate. The TIM accordingly forms a pathway for heat to flow from the battery and to the cooling plate while preventing an undesired electrical connection between the battery and the cooling plate.

The application of the TIM to the surface of the battery plate presents several challenges causing the application process to be inefficient and imprecise. Many TIMs utilized in conjunction with electrical components tend to be formed from relatively soft and pliable materials such as wax or silicone based polymeric materials. These materials tend to be difficult to manipulate and align properly, difficult to handle without introducing damage to the material, and difficult to lay flat without undesirably introducing flaws such as air bubbles and the like, wherein such issues may lead to the TIM failing to efficiently transfer the heat away from the battery and to the cooling plate or to prevent the formation of a short circuit between the cooling plate and the associated battery. Additionally, the difficulty inherent in manipulating a pliable sheet of the TIM causes such an application process to be timely and imprecise when such sheets are hand manipulated, even when such a process is performed by a skilled operator.

Furthermore, such sheets of TIM are traditionally limited to use with relatively small electrical components having maximum dimensions on the order of millimeters or centimeters. Such sheets are typically presented in planar form for application to a corresponding planar surface. The relative smallness of such sheets allows for the sheets to be easily picked up by a suitable automated means having a planar pick surface before easily transporting the sheet to the desired location relative to the corresponding substrate. However, in contrast, the batteries utilized in an electric or hybrid electric vehicle typically include relatively large planar surfaces having dimensions as great as or exceeding one meter. Such relatively large sheets become exceedingly difficult to manipulate due to the width and length dimensions of the sheet far exceeding the thickness dimension thereof, which leads to an increase in the pliability of the sheet as well as an increase in the surface area of the sheet that must be picked to prevent damage or misalignment of the sheet. The increase in the surface area of the sheet needed to be picked also introduces a greater likelihood that defects will be formed on the associated sheet as the traditional planar method of picking does not include a mechanism for ensuring that the entirety of the sheet is equally adhered to the picking surface during the picking process.

Accordingly, it would be desirable to a system and method for reliably and repeatedly picking and placing sheets of thermal interface material without misaligning or introducing defects into the sheets of the thermal interface material.

### SUMMARY OF THE INVENTION

Compatible and attuned with the present invention, a method of picking and/or placing a sheet of thermal interface material is disclosed. The method comprises the steps of: providing a cylinder roller configured to selectively adhere the sheet to an outer surface of the cylinder roller and rotating the cylinder roller relative to a planar surface with the sheet compressed between the cylinder roller and the planar surface.

According to another embodiment of the invention, a method of applying a sheet of material to a planar surface is disclosed. The method comprises the steps of: providing a cylinder roller configured to selectively adhere the sheet to an outer surface of the cylinder roller; picking the sheet from a substrate by rotating the cylinder roller relative to the substrate; and placing the sheet on the planar surface by rotating the cylinder roller relative to the planar surface.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a cross-sectional elevational view of a pick-and-place system according to an embodiment of the present invention;

FIG. 2 is a cross-sectional elevational view of the pick-and-place system as taken through section lines 2-2 of FIG. 1;

FIG. 3 is a cross-sectional elevational view of the pick-and-place system as taken through section lines 3-3 of FIG. 1;

FIGS. 4-6 are cross-sectional elevational views showing various different stages of a picking process performed by the pick-and-place system of FIG. 1;

FIG. 7 is an enlarged fragmentary cross-sectional elevational view of an encircled portion of FIG. 4;

FIGS. 8-10 are cross-sectional elevational views showing various different stages of a placing process performed by the pick-and-place system of FIG. 1;

FIG. 11 is a schematic cross-sectional elevational view illustrating an embodiment of the pick-and-place system wherein the cylinder roller is transported relative to a stationary substrate;

FIG. 12 is a schematic cross-sectional elevational view illustrating an embodiment of the pick-and-place system wherein a substrate is transported relative to a stationary cylinder roller;

FIG. 13 is a top plan view of a cylinder roller picking or placing a plurality of sheets of material simultaneously;

FIG. 14 is a cross-sectional elevational view of a cylinder roller picking or placing a plurality of sheets of material sequentially;

FIG. 15 is a schematic front elevational view of a cylinder roller of a pick-and-place system according to another embodiment of the present invention;

FIG. 16 is an enlarged fragmentary schematic front elevational view of a portion of the cylinder roller encircled in FIG. 15; and

FIG. 17 is a schematic cross-sectional elevational view of the pick-and-place system of FIG. 15 during a representative placing process.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The invention disclosed herein is directed towards a system and method for picking up and placing thermally conductive and electrically non-conductive sheet materials. In the provided application, the sheet material may be a thermal interface material (TIM). The TIM may be formed from a suitable sheet of a pliable material having the desired characteristics of thermal conductivity and electrical conductivity for the given application. The TIM may, for example, be formed from a sheet of material formed from a silicone, an epoxy, a urethane, an acrylic, or combinations thereof, as non-limiting examples. The TIM may be formed to be relatively soft and deformable in a manner wherein it may be desirable to avoid excessive handling of the sheet of material to avoid the introduction of wrinkles or tears when attempting to pick or place the sheet. The sheet of the TIM material will hereinafter be referred to as the sheet 5 for simplicity. The picking of the sheet 5 may be performed with respect to a substantially planar surface of a first substrate while the placing of the sheet 5 may be performed with respect to a substantially planar surface of a second substrate. The first substrate may be a structure associated with a manufacturing process for assembling a product including the second substrate, wherein the second substrate may be a portion of the product configured to receive the sheet 5 during the manufacturing process.

In the provided examples, the second substrate is a substantially planar portion of a cooling plate associated with a battery of an electric or hybrid electric vehicle. The cooling plate may normally act as a heat exchanger for removing heat from the battery during operation thereof, and the sheet 5 may be placed between the cooling plate and the associated battery in order to provide a thermally conductive and electrically non-conductive layer between the battery and the cooling plate. The inclusion of the sheet 5 accordingly ensures that electrical current is not undesirably transferred between the cooling plate and the battery while allowing for heat to be transferred from the battery to the ambient environment via the cooling plate.

As explained throughout, the general inventive concepts of the disclosed system may be applied to a variety of different structures and processes without departing from the scope of the present invention. As such, the examples provided herein are merely exemplary in nature and do not limit the possible configurations of the present invention. It should be apparent to one skilled in the art that the structures and methods disclosed herein may be easily adapted to a variety of alternative configurations and processes while maintaining the advantageous features of the present invention.

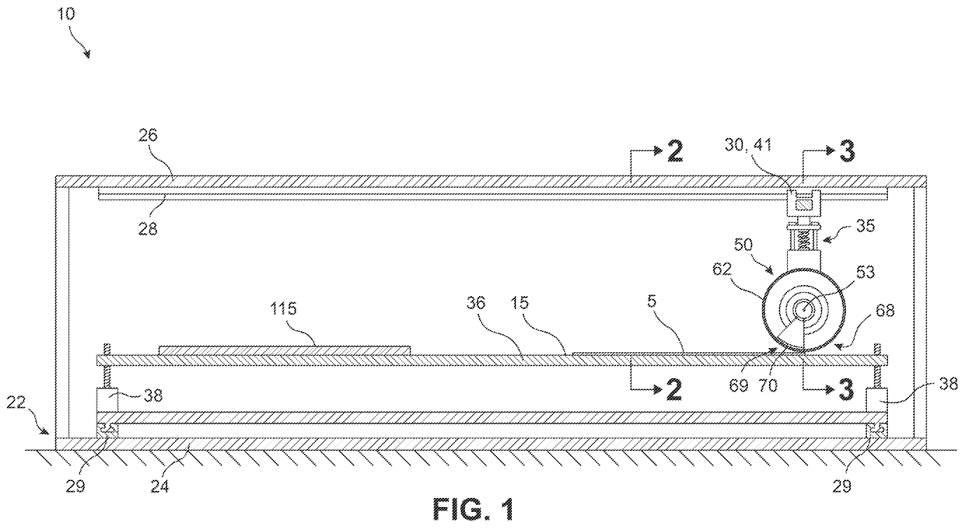

As one non-limiting example, FIGS. 1-14 illustrate a pick-and-place system 10 according to a first embodiment of the present invention. The pick-and-place system 10 generally includes a transport system 20 and a cylinder roller 50 according to an embodiment of the present invention. The pick-and-place system 10 is configured to be capable of both selectively picking up the sheet 5 of an associated TIM from a substantially planar surface of a first substrate 15 and also selectively placing the sheet 5 of the TIM at a desired position on a substantially planar surface of a second substrate 115. As described hereinafter, the first substrate 15 may be a substantially planar surface of the transport system 20 while the second substrate 115 may be a substantially planar surface of a cooling plate of a battery assembly.

The transport system 20 is configured to selectively establish a position of the cylinder roller 50 relative to the first substrate 15 when performing a picking process or to selectively establish a position of the cylinder roller 50 relative to the second substrate 115 when performing a placing process. The transport system 20 is also configured to allow or facilitate relative motion between the cylinder roller 50 and the associated substrate 15, 115 to cause the rolling of the cylinder roller 50 during the picking or placing process.

When the sheet 5 is disposed on the first substrate 15 prior to the picking process, the sheet 5 includes a first dimension referred to hereinafter as the length dimension extending in a first direction parallel to the substantially planar surface of the first substrate 15 and perpendicular to an axis of rotation 53 of the cylinder roller 50. The sheet 5 further includes a second dimension referred to hereinafter as the width dimension extending in a second direction parallel to the substantially planar surface of the first substrate 15 and the axis of rotation 53 of the cylinder roller 50 and a third dimension referred to hereinafter as the thickness dimension extending in a third direction arranged perpendicular to each of the first direction and the second direction. The first direction corresponds to a direction of travel of the cylinder roller 50 relative to the first substrate 15 when the cylinder roller 50 rolls relative thereto during an associated picking process. Similarly, a direction of travel of the cylinder roller 50 relative to the second substrate 115 when placing the sheet 5 on the corresponding second substrate 115 also occurs in the first direction corresponding to the length dimension of the placed sheet 5.

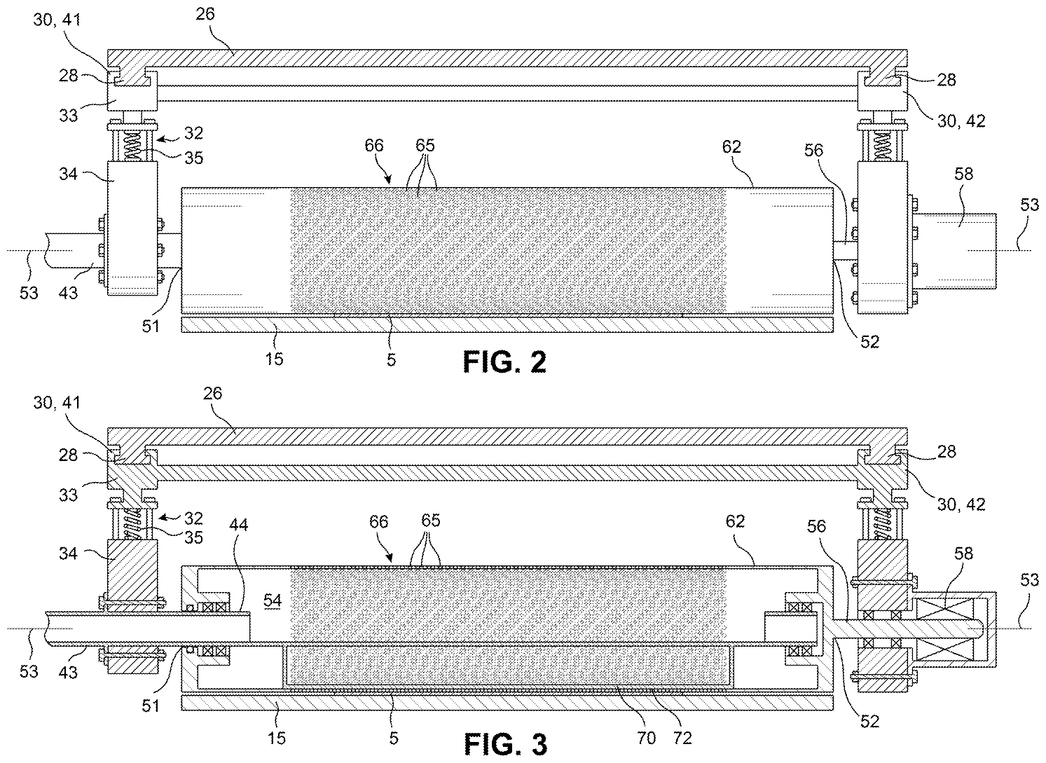

In the illustrated embodiment, the transport system 20 includes a frame 22 including both a base 24 disposed beneath the cylinder roller 50 and a support member 26 extending above the cylinder roller 50, wherein the cylinder roller 50 depends downwardly from the support member 26. As best shown in FIGS. 2 and 3, the support member 26 includes a pair of horizontally extending rails 28 depending therefrom with each of the rails 28 configured to engage one of a pair of spaced apart slider mechanisms 30. Each of the slider mechanisms 30 is configured to slidably engage one of the rails 28 in a manner wherein the slider mechanisms 30 can slide in unison and in a horizontal direction as shown from the perspective of FIG. 1. Each end of the cylinder roller 50 is supported by one of the slider mechanisms 30 such that the entirety of the cylinder roller 50 translates in the horizontal direction when the slider mechanisms 30 are translated in the horizontal direction. In the provided example, the horizontal direction corresponds to the first direction corresponding to the length dimension of the sheet 5 prior to the picking process or following the placing process. The slider mechanisms 30 may be caused to translate linearly relative to the rails 28 by connection of the slider mechanisms 30 to a suitable linear translation mechanism or system (not shown), such as a suitable conveyer system, pulley system, screw drive system, or the like. The associated mechanism or system may be driven by any type of suitable actuator (not shown), such as an electric motor.

Each of the slider mechanisms 30 further includes a spring assembly 32 configured for establishing continuous pressure between the cylinder roller 50 and the associated sheet 5 during the rolling of the cylinder roller 50 relative to the associated substrate 15, 115. Each of the spring assemblies 32 separates a first portion 33 of each of the slider mechanisms 30 coupled to one of the rails 28 from a second portion 34 of each of the slider mechanisms 30 coupled to one of the ends of the cylinder roller 50. The spring assembly 32 provides a downward spring force to the cylinder roller 50 from the perspective of FIGS. 1-3 when the cylinder roller 50 is placed in contact with the sheet 5 due to the second portion 34 of each of the slider mechanisms 30 being translated towards the corresponding first portion 33 of each of the slider mechanisms 30, thereby compressing a spring 35 of the spring assembly 32 between the first and second portions 33, 34. The spring force applied by the spring 35 ensures continuous compression of the sheet 5 between the cylinder roller 50 and the associated substrate 15, 115 during the rolling of the cylinder roller 50 relative to the associated substrate 15, 115. The spring assembly 32 may include a plurality of sliding connections disposed between the first and second portions 33, 34 of each of the slider mechanisms 30, wherein the sliding connections constrain the motion of each of the second portions 34 exclusively in the vertical direction from the perspective of FIGS. 1-3 during compression of the spring 35, wherein the vertical direction corresponds to the aforementioned third direction associated with the thickness dimension of the sheet 5 when disposed on the associated substrate 15, 115. The spring assembly 32 may alternatively include any type of mechanism suitable for applying a force in reaction to being compressed in the third direction, such as a pneumatic spring assembly, as one additional non-limiting example.

The base 24 includes a pair of rails 29 extending into the page from the perspective of FIG. 1, which corresponds to the rails 29 extending in the second direction corresponding to the width dimension of the sheet 5. A carriage 35 is slidably disposed on the rails 29 in a manner wherein the entirety of the carriage 35 and the remainder of the components supported by the carriage 35 move in unison when translating in the third direction. The carriage 35 may be caused to translate linearly relative to the rails 29 by connection of the carriage 35 to a suitable linear translation mechanism or system (not shown), such as a suitable conveyer system, pulley system, screw drive system, or the like. The associated mechanism or system may be driven by any type of suitable actuator (not shown), such as an electric motor.

The carriage 35 further supports a table 36, which in the present example forms the first substrate 15 on which the sheet 5 is disposed prior to the picking process as described hereinafter. As shown in FIG. 1, the table 36 may further support the second substrate 115 configured for receiving the sheet 5 thereon during the place process, wherein the second substrate 115 is representative of one of the cooling plates described previously. The table 36 is operatively coupled to a pair of screw drive assemblies 38 disposed on the carriage 35. Each of the screw drive assemblies 38 is configured to change an elevation of the table 36 relative to the carriage 35 and hence the base 24 by translating the table 36 exclusively in the vertical or third direction. The translation of the table 36 in the third direction towards the cylinder roller 50 is suitable for providing and maintaining the compression of the sheet 5 between the cylinder roller 50 and the associated substrate 15, 115 as caused by the reaction of the spring assembly 32. The disclosed screw drive assemblies 38 are merely representative of one possible form of linear translation mechanism or system and may be replaced with any such suitable mechanism or system, such as a conveyer system or a pulley system, as non-limiting examples.

Referring now to FIGS. 2 and 3, the slider mechanisms 30 include a first slider mechanism 41 coupled to a first end 51 of the cylinder roller 50 and a second slider mechanism 42 coupled to a second end 52 of the cylinder roller 50. The first slider mechanism 41 includes an opening for receiving a suction conduit 43 therethrough. The suction conduit 43 is securely coupled to the first slider mechanism 41 to cause the suction conduit 43 to move in unison with the first slider mechanism 41 and the cylinder roller 50 during a rolling of the cylinder roller 50 relative to the associated substrate 15, 115. The suction conduit 43 includes an open end 44 disposed within a hollow interior 54 of the cylinder roller 50 to place the hollow interior 54 in fluid communication with an interior of the suction conduit 43. The interior of the suction conduit 43 is placed in fluid communication with an air pump (not shown) configured to form a suction pressure within the suction conduit 43 and hence within the hollow interior 54 of the cylinder roller 50. The suction pressure may be a partial vacuum and is less than a pressure of the ambient environment surrounding the cylinder roller 50.

The first end 51 of the cylinder roller 50 is rotatably supported on the suction conduit 43 via bearings or the like to cause a central axis of the suction conduit 43 to coincide with the axis of rotation 53 of the cylinder roller 50. The second end 52 of the cylinder roller 50 may include a shaft 56 rotatably received in an opening formed in the second slider mechanism 42 via bearings or the like, wherein the shaft 56 is arranged co-axial with the axis of rotation 53 of the cylinder roller 50. The shaft 56 may be operatively coupled to a rotary actuator 58 configured to selectively rotate the cylinder roller 50 relative to the suction conduit 43 and hence about the axis of rotation 53 of the cylinder roller 50. The rotary actuator 58 may be an electric motor and may be configured to either drive rotation of the cylinder roller 50 during a rolling process thereof or to rotationally reposition the cylinder roller 50 before or after an associated picking process or placing process. For example, the rotary actuator 58 may selectively rotate the cylinder roller 50 to a desired rotational starting position before each subsequent picking or placing process, as desired.

The cylinder roller 50 includes an outer surface 62 defined by a circumferentially extending wall 64 of the cylinder roller 50. The outer surface 62 of the cylinder roller 50 includes a fixing region 66 suitable for selectively adhering the sheet 5 to the outer surface 62 during a picking or placing process. The fixing region 66 extends circumferentially about an entirety of the outer surface 62 while also extending across a preselected length of the outer surface 62 with respect to the second (width) direction. The fixing region 66 may be centrally located on the outer surface 62 with respect to the second direction, as desired. In the example provided in FIGS. 1-13, the fixing region 66 corresponds to a portion of the wall 64 having an array of suction openings 65 formed therethrough, wherein each of the suction openings 65 provides fluid communication between the ambient environment disposed exterior to the wall 64 and the hollow interior 54 of the cylinder roller 50. The suction openings 65 may be arranged to extend in the radial direction of the cylinder roller 50 about an entirety of the circumference of the fixing region 66. The suction openings 65 may be arranged in any pattern relative to outer surface 62, as desired, including an alternating nested configuration. Each of the suctions openings 65 may have any desired shape and size. The suctions openings 65 may be spaced from one another to ensure that gaps do not exist within the fixing region 66 devoid of any of the suction openings 65 with respect to the second direction or the circumferential direction of the cylinder roller 50.

As best shown in FIG. 7, which shows an enlarged fragmentary sectional view of the cylinder roller 50 immediately prior to the initiation of a picking process, the fixing region 66 of the outer surface 62 is divided circumferentially into an adhesion portion 68 and a non-adhesion portion 69. The adhesion portion 68 refers to a portion of the fixing region 66 that is instantaneously applying an adhesion force to the sheet 5 during a picking or placing process while the non-adhesion portion 69 refers to a portion of the fixing region 66 that is instantaneously devoid of the application of the adhesion force to the sheet 5 during the associated picking or placing process. The adhesion portion 68 and the non-adhesion portion 69 may each extend across an entirety of the fixing region 66 with respect to the second (width) direction. The adhesion portion 68 extends circumferentially along the outer surface 62 of the cylinder roller 50 through a first angular displacement while the non-adhesion portion 66 extends circumferentially along the outer surface 62 through a second angular displacement, wherein the first and second angular displacements cover the entirety of the circumference of the outer surface 62 along the fixing region 66. In the provided example, the first angular displacement is about 315 degrees while the second angular displacement is about 45 degrees. However, alternative angular displacements may be used while remaining within the scope of the present invention, as explained in greater detail hereinafter.

In the provided example, the adhesion force of the fixing region 66 is provided by the pressure differential present between the ambient environment at atmospheric pressure and the hollow interior 54 of the cylinder roller 50 when experiencing the suction pressure therein, which is present during activation of the air pump in fluid communication with the suction conduit 43. When the pressure differential is great enough, the adhesion force caused by the pressure differential is sufficient to adhere the sheet 5 to the outer surface 62 along the adhesion portion 68 to perform the associated picking or placing process.

The fixing region 66 is divided into the adhesion portion 68 and the non-adhesion portion 69 by the presence of a non-adhesion structure 70 within the cylinder roller 50. The non-adhesion structure 70 is configured to selectively block the flow of the air through a first portion of the suction openings 65 facing towards and terminating at the non-adhesion structure 70, wherein the portion of the fixing region 66 having the blocked suction openings 65 corresponds to the non-adhesion portion 69 thereof. Conversely, a second portion of the suction openings 65 corresponding to the adhesion portion 68 are unobstructed by the non-adhesion structure 70 and accordingly experience the pressure difference present between the ambient environment and the suction pressure within the hollow interior 54 of the cylinder roller 50, wherein the resulting adhesion force may be applied to any material adjacent or in contact with the adhesion portion 68 of the fixing region 66.

In the provided example, the non-adhesion structure 70 is formed by a wall 72 having a cylindrically shaped outer surface 73 corresponding in shape to the cylindrical inner surface of the wall 64. The wall 72 extends circumferentially through the second angular displacement corresponding to the angular displacement of the non-adhesion portion 69. The outer surface 73 of the wall 72 may be placed in sliding contact with the inner surface of the wall 64 in a manner sufficient for preventing the flow of the air through any suction openings 65 instantaneously facing towards the non-adhesion structure 70.

The non-adhesion structure 70 is shown as being securely coupled to or otherwise formed integrally with the suction conduit 43 in FIGS. 2 and 3, but the non-adhesion structure 70 may be securely coupled to any portion of the transport system 20 that does not rotate in unison with the wall 64 of the cylinder roller 50 during a picking or placing process while remaining within the scope of the present invention. As such, the non-adhesion structure 70 is configured to maintain an angular position thereof relative to the axis of rotation 53 of the cylinder roller 50 during a rolling of the cylinder roller 50 relative to the associated substrate 15, 115, and even as the cylinder roller 50 is translated relative to the associated substrate 15, 115 in the first direction during the rolling process. The manner in which the non-adhesion structure 70 maintains the angular position thereof while translating in the first direction is similar to the manner in which a rotational position of a handle or pin of a rolling pin is maintained even as the corresponding roller rotates and translates relative to the associated substrate during the rolling process. One skilled in the art should readily appreciate that the non-adhesion structure 70 may be incorporated into the structure of the cylinder roller 50 in a variety of different configurations while still maintaining the relationships disclosed herein so long as the wall 64 of the cylinder roller 50 rotates relative to the portion of the transport system 20 to which the non-adhesion structure 70 is securely coupled during a rolling of the cylinder roller 50.

A controller (not shown) may be in signal communication with the air pump associated with the suction conduit 43 as well as each of the aforementioned actuators responsible for transporting or rotating the cylinder roller 50 relative to an associated substrate. The controller may be preprogrammed to automatically carry out a picking-and-placing process as described hereinafter or the controller may be configured for manual control, as desired. Discussion hereinafter of any motion occurring with respect to the pick-and-place system 10 is assumed to occur in response to signal communication established with the controller.

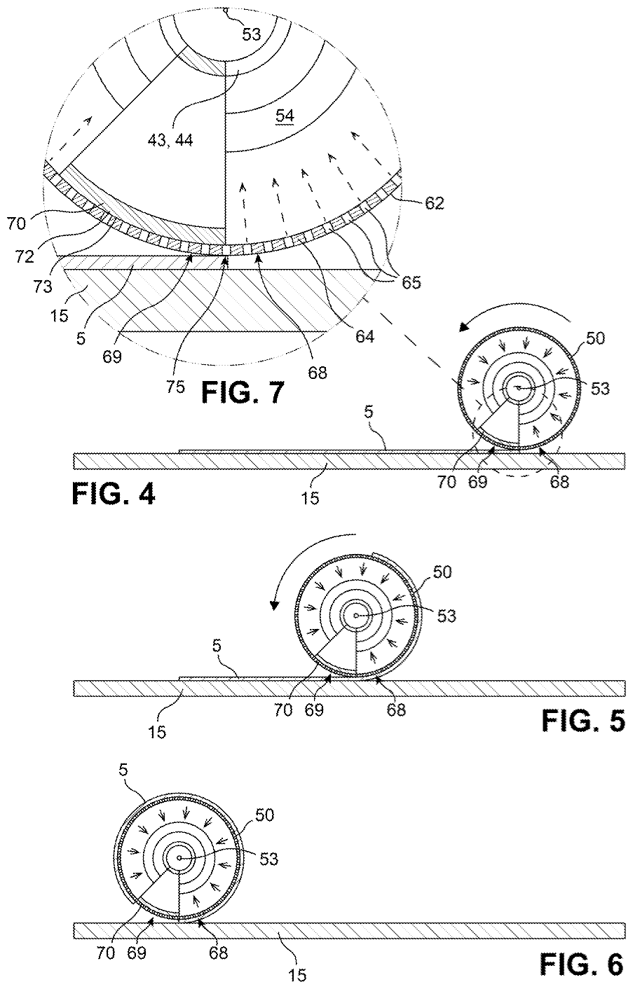

Referring now to FIGS. 4-6, a method of picking-up the sheet 5 using an associated picking process is shown and described. FIGS. 4-6 illustrate the cylinder roller 50, the sheet 5, and a portion of the table 36 forming the first substrate 15 in isolation for added clarity. Prior to the picking process, the transport system 20 is controlled to place the cylinder roller 50 at a desired position relative to the sheet 5 when disposed on the first substrate 15. The controlling of the transport system 20 may include activating any associated actuators required for creating relative movement between the cylinder roller 50 and the first substrate 15 to properly position the fixing region 66 of the cylinder roller 50 relative to an end of the sheet 5 with respect to the length dimension thereof. In the provided example, the cylinder roller 50 may be translated in the first direction relative to the first substrate 15 via movement of the slider mechanisms 30 with respect to the associated rails 28, the carriage 35 may be translated in the second direction relative to the cylinder roller 50 via movement of the carriage 35 with respect to the associated rails 29, and the table 36 forming the first substrate 15 may be translated in the third direction via activation of the screw drives 38 supporting the table 36. Once properly positioned, the table 36 may be further translated in the third direction towards the cylinder roller 50 to at least partially compress the spring 35 of each of the spring assemblies 32 when the sheet 5 is compressed between the first substrate 15 and the outer surface 62 of the cylinder roller 50, thereby causing the outer surface 62 of the cylinder roller 50 to apply continuous pressure to the underlying sheet 5 during a rolling of the cylinder roller 50.

FIG. 4 illustrates the cylinder roller 50 when placed in contact with the end of the sheet 5 and immediately prior to the rolling of the cylinder roller 50. As shown in FIG. 7, the outer surface 62 of the cylinder roller 50 includes a pressure portion 75 in contact with and applying pressure to the sheet 5 in the third (thickness) direction to compress the sheet 5 in the third direction between the pressure portion 75 of the outer surface 62 and the underlying first substrate 15. The pressure portion 75 is accordingly formed by a portion of the outer surface 62 arranged parallel to and facing directly towards the first substrate 15. As shown in FIG. 4, an angular position of the pressure portion 75 relative to the axis of rotation 53 of the cylinder roller 50 coincides with an angular position of an end of the non-adhesion structure 70. The pressure portion 75 accordingly defines one boundary between the adhesion portion 68 and the non-adhesion portion 69 of the fixing region 66. The non-adhesion portion 69 extends circumferentially from the pressure portion 75 through the desired angular displacement to space a second boundary between the adhesion portion 68 and the non-adhesion portion 69 formed by an opposing end of the non-adhesion structure 70 at a suitable circumferential distance from the pressure portion 75. The second boundary may be spaced circumferentially from the pressure portion 75 to avoid an incidence wherein the adhesion force is undesirably applied to a portion of the sheet 5 spaced from the pressure portion 75 with respect to the first direction. The angular displacement of the non-adhesion portion 69 away from the pressure portion 75 may accordingly be selected based on factors such as the weight of the sheet 5, the thickness of the sheet 5, the adhesion force generated by the pressure differential present at the suction openings 65, or the like, as desired.

Next, the air pump associated with the suction conduit 43 is activated to generate the suction pressure within the hollow interior 54 of the cylinder roller 50. The resulting pressure differential causes air to flow through the exposed suction openings 65 formed to either side of the non-adhesion structure 70 while flow is prevented from occurring in those suction openings 65 leading directly to the outer surface 73 of the wall 72 forming the non-adhesion structure 70.

When the air pump is first initiated, the end of the sheet 5 is substantially aligned with the pressure portion 75 of the cylinder roller 50 with respect to the first (length) direction of the sheet 5. As such, the end of the sheet 5 is disposed at the boundary between the adhesion portion 68 and the non-adhesion portion 69 in a manner wherein the end of the sheet 5 has not yet been subjected to the adhesion force generated by the adhesion portion 68.

The cylinder roller 50 is then caused to roll relative to the first substrate 15 as shown by comparison of FIGS. 4-6. The rolling may be initiated by actuation of the rotary actuator 58 or the rolling may be initiated via relative motion between the cylinder roller 50 and the first substrate 15 with respect to the first direction. Such relative motion in the first direction may be caused by translating the slider mechanisms 30 and the cylinder roller 50 relative to the rails 28 via an associated actuator, as desired.

The rolling includes counter-clockwise rotation of the wall 64 of the cylinder roller 50 relative to the non-rotating suction conduit 43 from the perspective of FIGS. 4-6. The rolling of the cylinder roller 50 causes the axis of rotation 53 and the non-adhesion structure 70 of the cylinder roller 50 to translate exclusively in the first direction from right-to-left while the non-adhesion structure 70 maintains the same rotational position relative to the axis of rotation 53 despite the rotation of the wall 64 of the cylinder roller 50 relative thereto. The rolling occurs with the non-adhesion portion 69 of the fixing region 66 facing towards the sheet 5 yet to be picked while the adhesion portion 68 faces away from the yet to be picked sheet 5. In other words, the direction of travel of the axis of rotation 53 of the cylinder roller 50 is the same as the direction the non-adhesion portion 69 generally faces towards during the rolling of the cylinder roller 50.

As should be understood, the rolling of the cylinder roller 50 results in different portions of the wall 64 and hence different ones of the suction openings 65 encountering the non-adhesion structure 70 as the wall 64 rotates relative to the non-adhesion structure 70. The portions of the wall 64 forming the adhesion portion 68 and the non-adhesion portion 69 are accordingly changing continuously during the rolling of the cylinder roller 50 while the angular position and displacement of the adhesion portion 68 and the non-adhesion portion 69 are maintained, respectively.

Once the rolling process begins, the end of the sheet 5 will immediately pass from the pressure portion 75 to the adhesion portion 68 as the axis of rotation 53 of the cylinder roller 50 translates in the first direction and the wall 64 rolls over the sheet 5. The instant any portion of the sheet 5 passes from the pressure portion 75 to the adhesion portion 68 with respect to the first direction the adhesion forces generated at the adhesion portion 68 will immediately adhere the sheet 5 to the outer surface 62 of the cylinder roller 50. This continuously occurs as the cylinder roller 50 continues to translate in the first direction to allow the sheet 5 to continuously adhere to the outer surface 62 while the sheet 5 travels circumferentially around the axis of rotation 53 of the cylinder roller 50. The rolling process beneficially compresses each subsequent portion of the sheet 5 at the instant the sheet 5 begins to adhere to the outer surface 62 when passing by the pressure portion 75. This continuous compression of the sheet 5 results in the elimination of wrinkles, air bubbles, or other defects that may otherwise be introduced into the sheet 5 when adhered to the cylinder roller 50.

The rolling continues until an entire length of the sheet 5 is disposed on and adhered to the adhesion portion 68 of the fixing region 66. As can be seen in FIG. 6, a diameter of the cylinder roller 50 as well as the angular displacement of the non-adhesion structure 70 may be selected wherein the sheet 5 substantially corresponds in length to the circumferential distance occupied by the adhesion portion 68 of the fixing region 66, as desired.

The transport system 20 is then actuated to translate the cylinder roller 50 away from the first substrate 15 in the third direction to fully remove the sheet 5 from the substrate 15. In the provided example, the table 36 may be translated vertically downward to space the cylinder roller 50 having the sheet 5 from the first substrate 15.

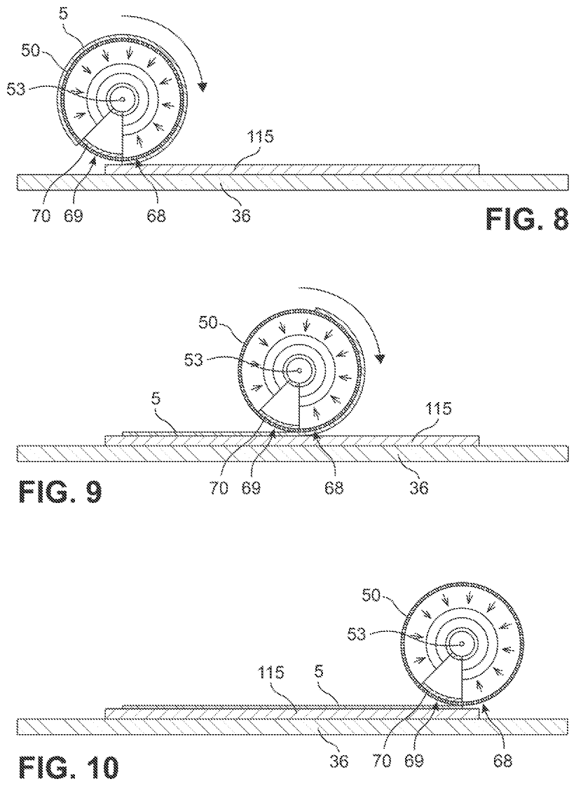

Referring now to FIGS. 8-10, a method of placing the sheet 5 on the associated second substrate 115 is shown and described. FIGS. 8-10 illustrate the cylinder roller 50, the sheet 5, the portion of the table 36 forming the first substrate 15, and the cooling plate forming the second substrate 115 in isolation for added clarity.

First, the cylinder roller 50 is positioned relative to the second substrate 115 via appropriate actuation of the transport system 20. In the provided example, the cylinder roller 50 may be translated along the rails 28 in the first direction until the cylinder roller 50 is disposed above the second substrate 115 at a desired position, such as a position suitable for centering the sheet 5 on the underlying second substrate 115. The cylinder roller 50 is then placed in pressurized contact with the second substrate 115 to compress an end of the sheet 5 between the pressure portion 75 of the cylinder roller 50 and the second substrate 115. The pressurized contact may be achieved by translating the table 36 upwardly in the vertical direction towards the cylinder roller 50. It should be understood that the adhesion forces generated by the adhesion portion 68 are maintained during the transport and subsequent placing of the cylinder roller 50 to avoid undesired removal of the sheet 5 from the cylinder roller 50.

The placing process occurs in substantially the same manner as the picking process except the cylinder roller 50 is caused to rotate in an opposite rotational direction during the rolling thereof in comparison to the disclosed picking process. In the provided example, the rolling during the placing process includes clockwise rotation of the wall 64 of the cylinder roller 50 relative to the non-rotating suction conduit 43 from the perspective of FIGS. 8-10 to cause the axis of rotation 53 of the cylinder roller 50 to translate in the first direction from left-to-right. As the wall 64 rotates relative to the axis of rotation 53, each subsequent portion of the sheet 5 continuously passes by the pressure portion 75 with respect to the first direction to cause the sheet 5 to continuously disengage from the outer surface 62 when passing the pressure portion 75. In similar fashion to the picking process, the placing process beneficially includes each subsequent portion of the sheet 5 being compressed at the instant the sheet 5 is disengaged from the cylinder roller 50 in a manner wherein wrinkles, air bubbles, or other defects caused by air entrapments are not introduced into the sheet 5 during the placing process.

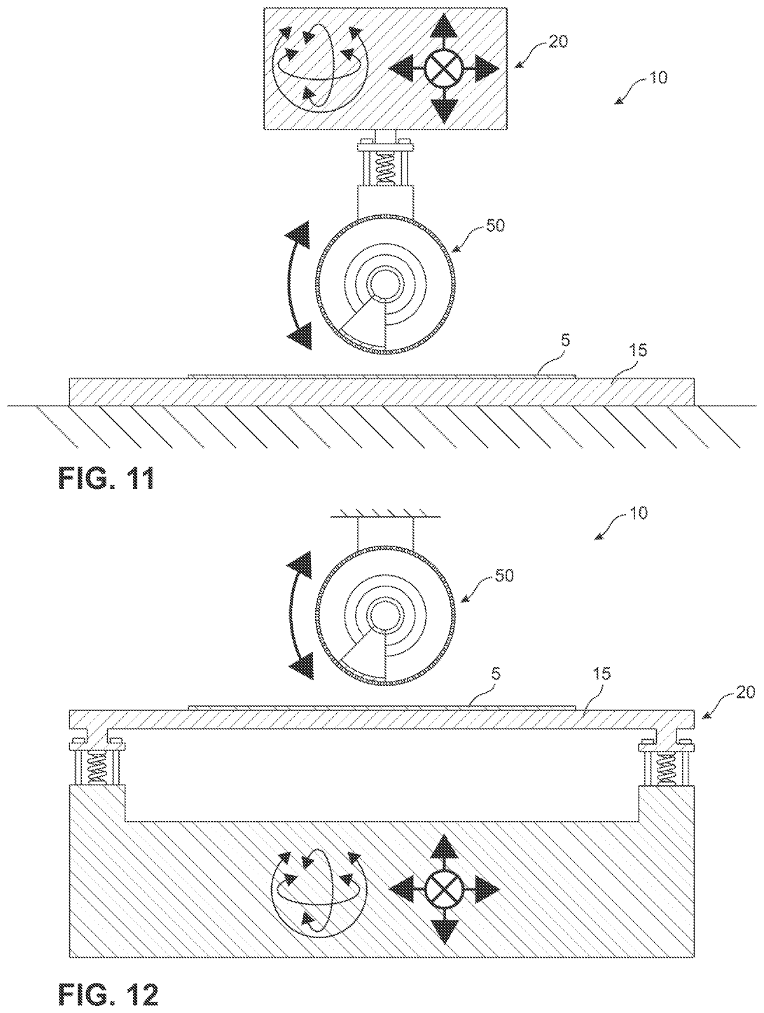

As described throughout, the transport system 20 may be modified in any number of respects to long as the general concepts of the present invention are maintained. For example, FIGS. 11 and 12 are partially schematic representations of alternative versions of the transport system 20 that distribute the different degrees of freedom of the transport system 20 alternatively. For example, FIG. 11 portrays the first substrate 15 as being stationary while the cylinder roller 50 is configured to translate in the first, second, and third directions relative to the stationary first substrate 15. Additionally, the cylinder roller 50 is further illustrated as being able to rotate about an axis corresponding to each of the disclosed directions. In contrast, FIG. 12 portrays the cylinder roller 50 as being substantially stationary while the first substrate 15 is configured to translate in or rotate about the first, second, and third directions relative to the stationary cylinder roller 50. In either event, it should be clear that the relative movement between the cylinder roller 50 and the remainder of the transport system 20 may be achieved by alternative means without altering the manner in which the cylinder roller 50 selectively adheres to or disengages from the sheet 5 based on a rolling direction of the cylinder roller 50 relative the underlying substrate 15, 115. The different degrees of freedom necessary for operation of the pick-and-place system 10 may accordingly be distributed in any suitable manner between the motion of the cylinder roller 50 and the motion of the underlying substrate 15, 115 for achieving the picking and placing processes disclosed herein.

It should also be apparent that the disclosed directions of travel do not refer to absolute directions, but rather refer to directions relative to a reference frame established during each and every picking or placing process. Specifically, the first, second, and third directions refer to the orientation of the sheet 5 relative to the rolling of the cylinder roller 50 and not to absolute spatial coordinates. It can readily be conceived that a portion of the transport system 20 may further rotate or otherwise further alter an orientation of the cylinder roller 50 relative to the associated substrates 15, 115 in a manner wherein the picking process and the placing process do not occur with parallel first directions of travel of the cylinder roller 50. For example, the configuration shown in FIG. 10 may be representative of a multi-axis robot (not shown) having the cylinder roller 50 provided as an end tool in a manner wherein the cylinder roller 50 can be both translated and rotated to various different configurations relative to either of the provided substrates 15, 115. The robot may position the cylinder roller 50 relative to the first substrate 15 for performing the picking process before relocating and reorienting the cylinder roller 50 for performing the placing process relative to a spaced apart second substrate 115, wherein the rolling for each process does not occur in a common or parallel direction. Such reorientation may include altering the rolling direction by about 90 degrees by rotating the associated robot about an axis arranged parallel to the third (vertical) direction, as one non-limiting example.

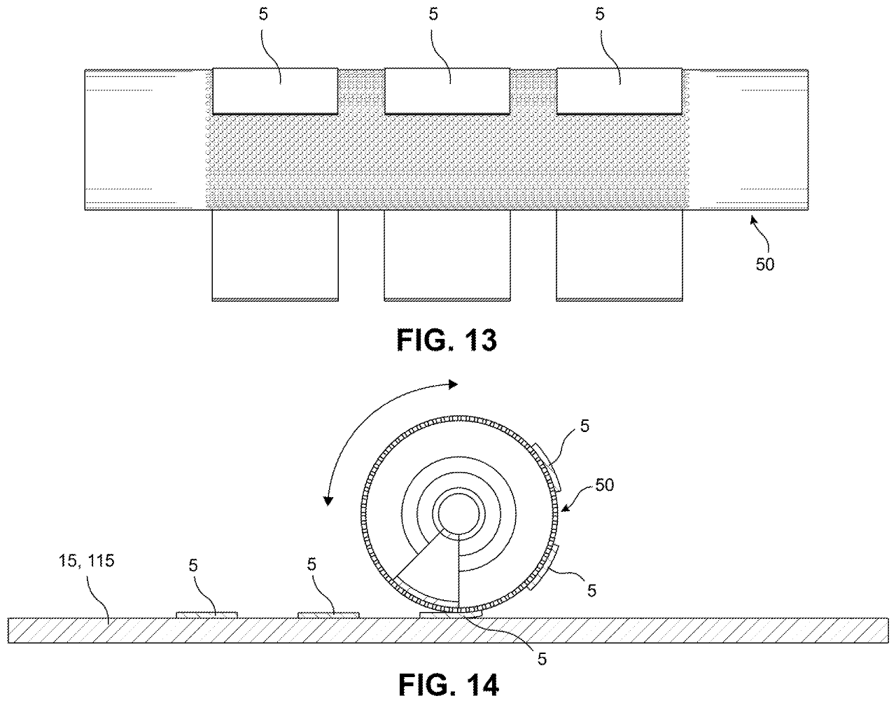

The cylinder roller 50 is also capable of picking and placing a plurality of the sheets 5 during a single picking or placing process. For example, FIG. 13 illustrates one example wherein three of the sheets 5 are spaced from each other in the second (width) direction of the cylinder roller 50 with each of the sheets 5 aligned with the fixing region 66 of the cylinder roller 50. Such a configuration allows for the simultaneous picking-and-placing of the three of the sheets 5. Alternatively, FIG. 13 illustrates one example wherein five of the sheets 5 are spaced from each other in the first (length) direction to cause the five of the sheets 5 to be circumferentially spaced from each other when adhered to the adhesion portion 68 of the cylinder roller 50. The subsequent placing of the five sheets 5 may occur in order wherein the sheets 5 are spaced at intervals in the first direction corresponding to the spacing of the sheets 5 in the first direction prior to the picking process. Alternatively, the rotary actuator 58 of the cylinder roller 50 may be configured to selectively rotate the cylinder roller 50 between each placing of each of the sheets 5 to avoid the presence of lengthwise gaps between the different sheets 5, as desired, or to locate the next of the sheets 5 for placement following a repositioning via the transport system 20.

The picking-or-placing of multiple sheets 5 may be performed with respect to a single second substrate 115 or may be performed with respect to a plurality of the second substrates 115. For example, the picking-and-placing of multiple sheets 5 spaced in the second direction as shown in FIG. 13 allows for the sheets 5 to either be applied to various different portions of a common second substrate 115 or for the sheets 5 to be applied to a plurality of independently provided second substrates 115 spaced from each other in the second direction during the placing process. Similarly, the picking-and-placing of multiple sheets 5 spaced in the first direction as shown in FIG. 14 also allows for the sheets 5 to be applied to various different positions on a common second substrate 115 or to be applied to a plurality of independently provided second substrates 115 spaced from each other in the first direction during the placing process.

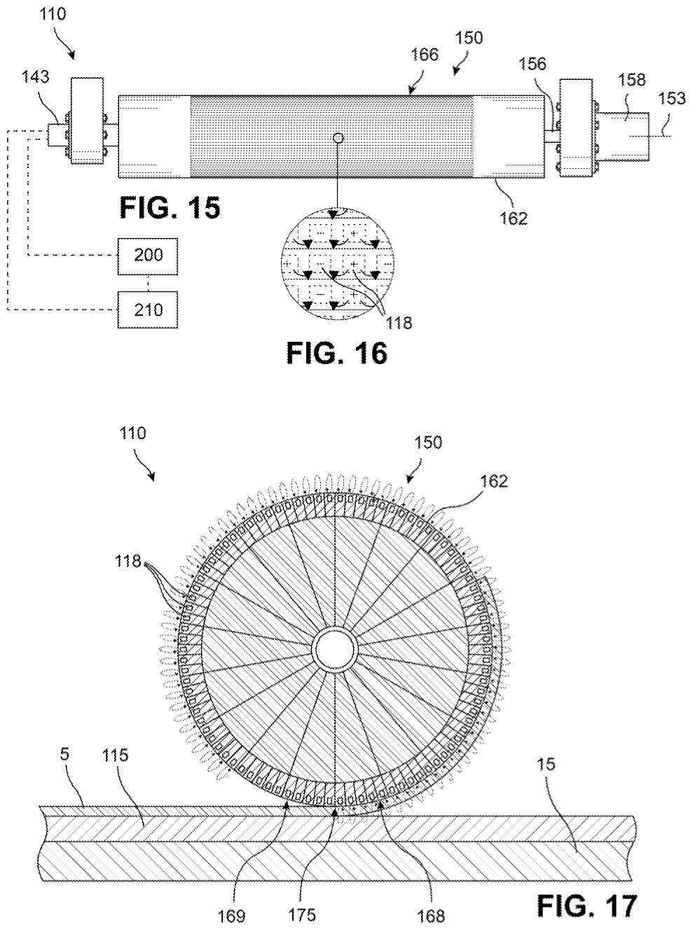

The pick-and-place system 10 illustrated in FIGS. 1-14 utilizes a mechanical relationship to maintain the respective angular positions and displacements of the adhesion portion 68 and the non-adhesion portion 69 during the rolling of the cylinder roller 50. In contrast, FIGS. 15-17 illustrate a pick-and-place system 110 according to another embodiment of the present invention having a cylinder roller 150 that maintains the respective angular positions and displacements of an adhesion portion 168 and a non-adhesion portion 169 via use of a controller 200 that selectively applies the adhesion force during the rolling of the cylinder roller 150.

The cylinder roller 150 may be associated with any of the transport system configurations disclosed herein so long as the associated transport system 20 is able to properly position and orient the cylinder roller 150 relative to the associated substrate 15, 115 with respect to each of the disclosed directions, apply pressure to the sheet 5 when disposed between the cylinder roller 150 and the corresponding sheet 5 in the third direction, and cause the relative rolling motion between the cylinder roller 150 and the associated substrate 15, 115 in the first direction during a picking or placing process. The controller 200 may be configured to communicate with each relevant component forming the transport system in order to carry out any of the tasks described herein with respect to the transport system.

The cylinder roller 150 is coupled an electrical conduit 143 at one end thereof. The electrical conduit 143 is similar to the suction conduit 43 in that the electrical conduit 143 includes a hollow opening in fluid communication with an interior of the cylinder roller 150 while also being configured to remain rotationally stationary while the cylinder roller 150 rotates relative to the electrical conduit 143. The cylinder roller 150 may be rotationally coupled to the electrical conduit 143 using bearings or the like, as desired. An opposing end of the cylinder roller 150 includes a shaft 156 coupled to a rotary actuator 158, wherein the rotary actuator 158 is responsible for selectively rotating the shaft 156 and hence the cylinder roller 150. As explained above, the cylinder roller 150 may alternatively be formed in the absence of the shaft 156 coupled to the rotary actuator 158 if the cylinder roller 150 is rotationally supported at each end and caused to rotate via translation of the associated transport system during a rolling process in similar fashion to the rolling action of a rolling pin.

The hollow interior of the electrical conduit 143 is configured to convey electrical cables or connections from an exterior of the cylinder roller 150 to the interior thereof. The electrical cables or connections may be associated with the controller 200 as well as a power source 210 associated with operation of the cylinder roller 150. The controller 200 may also be in signal communication with the power source 210, wherein the controller 200 is responsible for activating or deactivating the power source 210 when selectively powering desired portions of the cylinder roller 150, as explained hereinafter.

The cylinder roller 150 includes an outer surface 162 having a fixing region 166 that is divided into the adhesion portion 168 and the non-adhesion portion 169 in similar fashion to the cylinder roller 50. However, in contrast to the utilization of a mechanical structure for creating the division between the adhesion portion 66 and the non-adhesion portion 69 of the cylinder roller 50, the cylinder roller 150 instead utilizes a control scheme as carried out by the controller 200 to achieve the division between the adhesion portion 168 and the non-adhesion portion 169.

The controller 200 is responsible for selectively generating an adhesion force along the adhesion portion 168 of the fixing region 166 while concurrently not generating the adhesion force within the non-adhesion portion 169 of the fixing region 166 to form the division between the two portions 168, 169. In the provided example, the adhesion force may be an electromagnetic force configured for interacting with an associated sheet 5 in order to adhere the sheet 5 to the outer surface 162 of the cylinder roller 150. Specifically, the electromagnetic force may be applied as an electrostatic adhesive force, which is hereinafter referred to as “electroadhesion.” As the term is used herein, “electroadhesion” refers to the mechanical coupling of two objects using electrostatic forces. Electroadhesion as described herein uses electrical control of these electrostatic forces to permit temporary and detachable attachment between two objects. This electroadhesion holds two surfaces of these objects together or increases the traction or friction between two surfaces due to electrostatic forces created by an applied electric field.

In the present invention, the cylinder roller 150 includes a plurality of electrodes 118 disposed on or adjacent the outer surface 162 of the cylinder roller 150 along the fixing region 166 thereof. The electrodes 118 are shown as being formed in a grid extending in the second (width) direction and the circumferential direction of the cylinder roller 150, but any suitable pattern of the electrodes 118 may be utilized, as desired. Each of the electrodes 118 is in communication with the controller 200 and the power source 210.

As shown in the enlarged fragmentary view of FIG. 16, the controller 200 is configured to apply an electroadhesion voltage to the electrodes 118 in a manner wherein adjacent ones of the electrodes encountering alternating positive and negative charges. The voltage difference that is generated between the adjacent electrodes 118 causes the electroadhesion to occur, wherein the electroadhesion is suitable for adhering she sheet 5 to the outer surface 162 of the cylinder roller 150 along those regions thereof wherein the electroadhesion is generated by the electrodes 118.

The controller 200 accordingly provides the division between the adhesion portion 168 and the non-adhesion portion 169 by selectively applying the electroadhesive voltages only to those electrodes 118 forming the adhesive portion 168 of the fixing region 166. The controller 200 is further configured to continuously monitor or otherwise be aware of the relative rotational position of the cylinder roller 150 relative to an axis of rotation 153 thereof. As such, the controller 200 is aware of the angular position of each of the electrodes 118 with respect to the circumferential direction of the cylinder roller 150.

The electrodes 118 move in unison with the remainder of the outer surface 162 of the cylinder roller 150 during a picking or a placing process. Despite this rotational movement, the awareness of the controller 200 of the angular position of each of the electrodes 118 allows the controller 200 to selectively apply the electroadhesion voltage only to those electrodes 118 disposed at angular positions relative to the axis of rotation 153 that correspond to the adhesion portion 168 while those electrodes 118 corresponding to the non-adhesion portion 169 do not experience the electroadhesion voltage. The controller 200 accordingly has to continuously modify which of the electrodes 118 experiences the electroadhesion voltage during the rolling of the cylinder roller 150 to maintain the angular position of each of the adhesion portion 168 and the non-adhesion portion 169.

For example, FIG. 17 illustrates the cylinder roller 150 as performing a placing process regarding one of the sheets 5 relative to the second substrate 115. The cylinder roller 150 applies pressure to the sheet 5 at a pressure portion 175 thereof arranged parallel to the second substrate 115. If the pressure portion 175 is considered to be a rotational position of 0 degrees relative to the axis of rotation 153, the adhesion portion 168 is shown as extending circumferentially in the counter-clockwise direction from the 0 degree position to a position of about 320 degrees while the non-adhesion portion 169 extends from the rotational position of about 320 degrees to the pressure portion 175 disposed at the 0/360 degree position. The controller 200 accordingly makes a determination to only apply the electroadhesion voltage to those electrodes 118 corresponding to the positions between 0 and 320 degrees in the counter-clockwise direction during the rotation of the cylinder roller 150 relative to the axis of rotation 153 thereof.

The cylinder roller 150 otherwise operates in the same manner as disclosed hereinabove with regards to the cylinder roller 50, wherein the cylinder roller 150 rotates in one rotational direction during the picking process before rotating in the opposing rotational direction during the placing process. The cylinder roller 150 also aids in preventing air entrapment or other defects by continuously compressing the sheet 5 immediately before the forces generated by the electroadhesion are applied or disengaged when the sheet 5 passes by the pressure portion 175.

The present invention accordingly discloses two alternative methods of achieving the rotationally stationary adhesion portions 68, 168 and non-adhesion portions 69, 169 during a rolling of the corresponding cylinder roller 50, 150 during either of a picking or a placing process. It should further be understood that the general concepts disclosed herein may be further adapted to alternative adhesion forces, structural configurations, and the like in accordance with the teachings of the present invention.

As one example, an adhesive may be utilized for forming the adhesive forces while remaining within the scope of the present invention. With renewed reference to the cylinder roller 50 disclosed in FIGS. 1-14, the suction openings 65 may instead be configured to distribute an adhesive to the outer surface 62 of the cylinder roller 50 while the non-adhesion structure 70 may be configured to block or otherwise prevent the application of such adhesive, thereby establishing a division between an adhesion portion and a non-adhesion portion.

As another example, instead of a mechanical structure in the form of the non-adhesion structure 70 that remains stationary relative to the rotation of the cylinder roller 50, the cylinder roller 50 may instead be adapted to include control similar to that described with reference to the cylinder roller 150. Such a configuration may include localized valve elements or the like associated with different ones of the suction openings 65, wherein a suitable controller only opens those valve elements associated with the suction openings 65 disposed at angular positions corresponding to the adhesion portion 68 of the cylinder roller 50.

As yet another example, the control scheme disclosed with regards to the electroadhesion method may alternatively be replaced with a mechanical structure for controlling the division between the adhesion portion and the non-adhesion portion. For example, a brush or other electrical connector may only be present along the adhesion portion 168 of the cylinder roller 150 such that the electroadhesion voltage is only able to be applied to those electrodes 118 adjacent and in contact with the electrical connector. The electrodes 118 accordingly rotate relative to the otherwise stationary electrical connector while different ones of the electrodes 118 are activated during the rolling of the cylinder roller 150. Alternatively, a structure discontinuing or otherwise interrupting the current applied to the electrodes 118 may instead be associated with the non-adhesion portion 169 to create the same effect.

Alternative adhesion forces may also be utilized in accordance with the concepts of the present invention in addition to those described herein. The adhesion forces may be generated by any type of selectively generated or applied attractive force suitable for adhering one of the sheets to the outer surface of the corresponding cylinder roller. The adhesion force may for example be generated as an electromagnetic attractive force suitable for attracting one of the sheets thereto or may be generated by the attractive forces of chemical bonding or the like. Such attractive forces may be applied using the methods and structures disclosed herein.

The invention disclosed herein provides numerous advantages over the prior art. The use of the cylinder roller 50, 150 in place of a planar picking method provides the advantage of rolling the sheet during the picking and placing processes such that the sheet is prevented from forming defects such as those normally caused by air entrapment. The rolling process also leads to a more homogeneous installation of the TIM across the entirety of the corresponding surface. The use of the cylinder roller 50, 150 also allows for a plurality of the sheets to be easily and reliably picked or placed during an associated process for efficiently manufacturing a plurality of the associated components such as the disclosed cooling plates. The use of the cylinder roller 50 also reduces the dimensions of the system utilizing the cylinder roller as the length dimension of the associated sheet is wrapped circumferentially around the cylinder roller 50, thereby limiting the space occupied by any system of assembly utilizing the cylinder roller.

The present invention is especially during a manufacturing of the cooling plates disclosed herein. Such cooling plates typically require the application of a TIM that is especially pliable and subject to the introduction of manufacturing defects or misalignments due to the relatively large size of such sheets. For example, the associated cooling plates may include surfaces configured to receive one of the sheets having width or length dimensions exceeding 10 cm or even 1 m. The method disclosed herein accordingly provides for a method of quickly and efficiently covering a relatively large surface of a heat exchanger with one of the sheets while ensuring the application of the one of the sheets occurs without the introduction of defects or misalignments. Additionally, the systems and methods disclosed herein are also especially well adapted to achieving a manufacturing step with respect to a plurality of the cooling plates during either the picking process or the placing process based on the manner in which the disclosed system and method can easily accommodate a plurality of sheets spaced in the width direction, the length direction, or combinations thereof.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of picking or placing a sheet of material, the method comprising the steps of:
providing a cylinder roller configured to selectively adhere the sheet to an outer surface of the cylinder roller; and
rotating the cylinder roller relative to a planar surface with the sheet compressed between the cylinder roller and the planar surface.

2. The method of claim 1, wherein the outer surface of the cylinder roller is divided circumferentially into an adhesion portion and a non-adhesion portion, the adhesion portion configured to adhere the sheet to the outer surface of the cylinder roller.

3. The method of claim 2, wherein a position of the non-adhesion portion is maintained relative to an axis of rotation of the cylinder roller during the rotating of the cylinder roller relative to the planar surface.

4. The method of claim 3, wherein a pressure portion of the outer surface of the cylinder roller corresponds to a portion of the outer surface arranged parallel to the planar surface while applying pressure to the sheet during the rotating of the cylinder roller relative to the planar surface, wherein the pressure portion forms a first boundary between the adhesion portion and the non-adhesion portion.

5. The method of claim 4, wherein a second boundary between the non-adhesion portion and the adhesion portion is spaced circumferentially from the first boundary with respect to the outer surface of the cylinder roller.

6. The method of claim 4, wherein the sheet adheres to or disengages from the outer surface of the cylinder roller when the sheet passes by the pressure portion during the rotating of the cylinder roller relative to the planar surface.

7. The method of claim 2, wherein the non-adhesion portion faces towards a portion of the sheet disposed on the planar surface prior to the portion of the sheet being adhered to the adhesion portion of the outer surface of the cylinder roller during the picking process.

8. The method of claim 2, wherein the non-adhesion portion faces towards a portion of the sheet disposed on the planar surface after the portion of the sheet has been removed from the adhesion portion of the outer surface of the cylinder roller during the placing process.

9. The method of claim 2, wherein an adhesion force adheres the sheet to the outer surface of the cylinder roller.

10. A method of applying a sheet of material to a planar surface, the method comprising the steps of:
providing a cylinder roller configured to selectively adhere the sheet to an outer surface of the cylinder roller;
picking the sheet from a substrate by rotating the cylinder roller relative to the substrate; and
placing the sheet on the planar surface by rotating the cylinder roller relative to the planar surface.

11. The method of claim 10, wherein the outer surface of the cylinder roller is divided circumferentially into an adhesion portion and a non-adhesion portion, the adhesion portion configured to adhere the sheet to the outer surface of the cylinder roller.

12. The method of claim 11, wherein a position of the non-adhesion portion is maintained relative to an axis of rotation of the cylinder roller during the rotating of the cylinder roller relative to either of the substrate or the planar surface.

13. The method of claim 12, wherein a position of a structure corresponding to the non-adhesion portion is maintained relative to the axis of rotation of the cylinder roller during the rotating of the cylinder roller relative to either of the substrate or the planar surface.

14. The method of claim 13, wherein the cylinder roller includes a plurality of suction openings formed therein and an adhesion force is formed by a pressure differential across the suction openings, wherein the structure is configured to fluidly block the suction openings disposed along the non-adhesion portion.

15. The method of claim 12, wherein a controller selectively generates an adhesion force along the adhesion portion.

16. The method of claim 15, wherein the adhesion force is an electroadhesion.

17. The method of claim 12, wherein a pressure portion of the outer surface of the cylinder roller corresponds to a portion of the outer surface arranged parallel to the substrate or the planar surface while applying pressure to the sheet during the rotating of the cylinder roller relative to the substrate or the planar surface, wherein the pressure portion forms a first boundary between the adhesion portion and the non-adhesion portion.

18. The method of claim 17, wherein a second boundary between the non-adhesion portion and the adhesion portion is spaced circumferentially from the first boundary with respect to the outer surface of the cylinder roller.

19. The method of claim 10, wherein the picking step includes picking a plurality of the sheets and the placing step includes placing the plurality of the sheets.

20. The method of claim 11, wherein the picking of the sheet includes the cylinder roller rotating in a first rotational direction and the placing of the sheet includes the cylinder roller rotating in a second rotational direction opposite the first rotational direction.
